(19) United States
(12) Patent Application Publication
(10) Pub. No.: US 2007/0291109 A1
(43) Pub. Date: Dec. 20, 2007

(54) Remote controlled mobile robot with auxillary input ports

(76) Inventors: Yulun Wang, Goleta, CA (US); Charles S. Jordan, Santa Barbara, CA (US); Marco Pinter, Santa Barbara, CA (US); Michael C. Chan, Santa Barbara, CA (US)

Correspondence Address: IRELL & MANELLA LLP, 840 NEWPORT CENTER DRIVE, SUITE 400, NEWPORT BEACH, CA, 92660, US

(21) Appl. No.: 11/542,605

(22) Filed: Oct. 2, 2006

Related U.S. Application Data
(63) Continuation-in-part of application No. 11/455,161, filed on Jun. 15, 2006.

(51) Int. Cl. H04N 7/14; G06F 19/00

(52) U.S. Cl. 348/14.05; 700/245

(57) ABSTRACT

A remote controlled robot system that includes a mobile robot and a remote control station. The mobile robot and remote control station include cameras, monitors, speakers and microphones that allow for two-way videoconferencing between the robot and station. The mobile robot includes an auxiliary video port that can be coupled to one or more external video devices. The video devices can capture video that is transmitted to the remote control station and displayed by the station monitor.

### CROSS-REFERENCE TO RELATED APPLICATION

This application is a continuation-in-part of U.S. application Ser. No. 11/455,161, filed on Jun. 15, 2006.

### BACKGROUND OF THE INVENTION

1. Field of the Invention

The subject matter disclosed generally relates to the field of mobile two-way teleconferencing.

2. Background Information

There has been marketed a mobile robot introduced by InTouch Technologies, Inc., the assignee of this application, under the trademarks COMPANION, RP-6 and RP-7. The InTouch robot is controlled by a user at a remote station. The remote station may be a personal computer with a joystick that allows the user to remotely control the movement of the robot. Both the robot and remote station have cameras, monitors, speakers and microphones to allow for two-way video/audio communication. The robot camera provides video images to a screen at the remote station so that the user can view the robot's surroundings and move the robot accordingly.

The InTouch robot can be used by medical personnel to monitor and interact with a patient. For example, a doctor can move the robot into a patient's room and utilize the two-way videoconferencing capabilities of the system to examine the patient. Examination of the patient is limited to visual inspection and audio feedback. It would be desirable if the system would also allow other devices to be used to examine and interact with a patient.

### BRIEF SUMMARY OF THE INVENTION

A remote controlled robot system that includes a mobile robot and a remote control station. The mobile robot includes a robot monitor, and a robot camera that captures a robot image. The remote station has a monitor that displays the robot image and a camera that captures a station image that is displayed by the robot monitor. The system also includes a video device that is coupled to an auxiliary video port of the mobile robot. The video device provides video that is displayed by the remote control station monitor.

### BRIEF DESCRIPTION OF THE DRAWINGS

FIG. 1 is an illustration of a robotic system;

FIG. 2 is a schematic of an electrical system of a robot;

FIG. 3 is a further schematic of the electrical system of the robot;

FIG. 4 is a graphical user interface of a remote station;

### DETAILED DESCRIPTION

Disclosed is a remote controlled robot system that includes a mobile robot and a remote control station. The mobile robot and remote control station include cameras, monitors, speakers and microphones that allow for two-way videoconferencing between the robot and station. The mobile robot includes an auxiliary video port that can be coupled to one or more external video devices. The video devices can capture video that is transmitted to the remote control station and displayed by the station monitor.

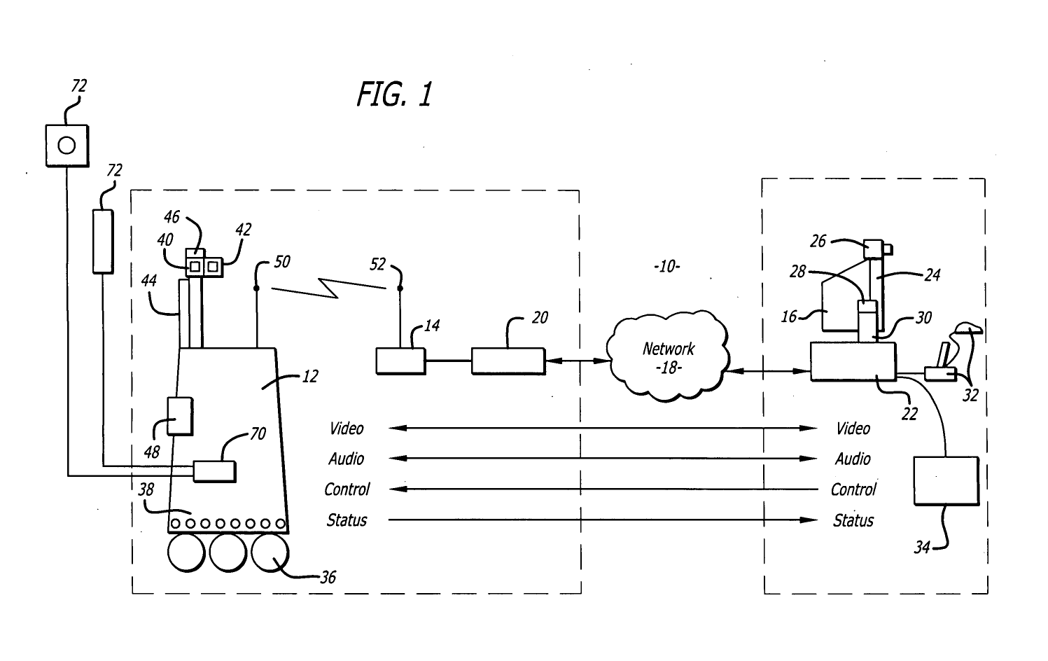

Referring to the drawings more particularly by reference numbers, FIG. 1 shows a robotic system 10 that can be used to conduct a remote visit. The robotic system 10 includes a robot 12, a base station 14 and a remote control station 16. The remote control station 16 may be coupled to the base station 14 through a network 18. By way of example, the network 18 may be either a packet switched network such as the Internet, or a circuit switched network such has a Public Switched Telephone Network (PSTN) or other broadband system. The base station 14 may be coupled to the network 18 by a modem 20 or other broadband network interface device. By way of example, the base station 14 may be a wireless router. Alternatively, the robot 12 may have a direct connection to the network thru for example a satellite.

The remote control station 16 may include a computer 22 that has a monitor 24, a camera 26, a microphone 28 and a speaker 30. The computer 22 may also contain an input device 32 such as a joystick and/or a mouse and a keyboard 34. The control station 16 is typically located in a place that is remote from the robot 12. Although only one remote control station 16 is shown, the system 10 may include a plurality of remote stations. In general any number of robots 12 may be controlled by any number of remote stations 16 or other robots 12. For example, one remote station 16 may be coupled to a plurality of robots 12, or one robot 12 may be coupled to a plurality of remote stations 16, or a plurality of robots 12.

Each robot 12 includes a movement platform 36 that is attached to a robot housing 38. Also attached to the robot housing 36 is a pair of cameras 40 and 42, a monitor 44, a microphone(s) 46 and a speaker(s) 48. The microphone 46 and speaker 30 may create a stereophonic sound. The robot 12 may also have an antenna 50 that is wirelessly coupled to an antenna 52 of the base station 14. The robot monitor 44 and cameras 40 and 82 move together in two degrees of freedom including pan and tilt directions. The system 10 allows a user at the remote control station 16 to move the robot 12 through operation of the input device 32. The robot cameras 40 and 42 are coupled to the remote monitor 24 so that a user at the remote station 16 can view a patient. Likewise, the robot monitor 44 is coupled to the remote camera 26 so that the patient can view the user. The microphones 28 and 46, and speakers 30 and 48, allow for audible communication between the patient and the user.

Camera 40 may provide a wide angle view. Conversely, camera 42 may contain a zoom lens to provide a narrow angle view. Camera 42 can capture a zoom image that is transmitted to the remote control station. Camera 40 can capture a non-zoom image that can be transmitted to the remote control station. Although two cameras are shown and described, it is to be understood that the robot may contain only one camera that has the capability to provide a zoom image and a non-zoom image.

The remote station computer 22 may operate Microsoft OS software and WINDOWS XP or other operating systems such as LINUX. The remote computer 22 may also operate a video driver, a camera driver, an audio driver and a joystick driver. The video images may be transmitted and received with compression software such as MPEG CODEC.

The robot 12 may include an auxiliary video port 70. The auxiliary video port 70 may include USB, VGA, Y-video/audio electrical connectors and associated electronic circuitry. A plurality of video devices 72 can be connected to one or more of the ports 70. By way of example, the video devices 72 may include an otoscope, a ceiling camera and/or a video playback machine such as a VCR or DVD player. The video devices 72 capture video that is transmitted to the remote station 16 through the mobile robot 12. By way of example, an otoscope may capture images of a patient that are then transmitted to the remote control station 16 and displayed by the station monitor 24.

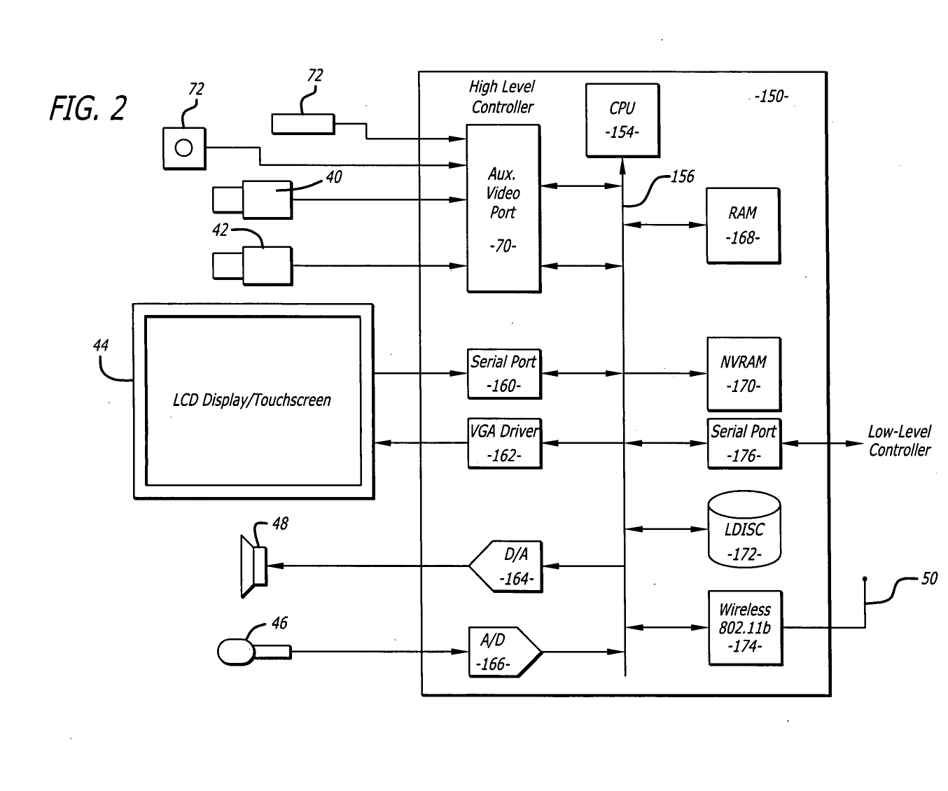

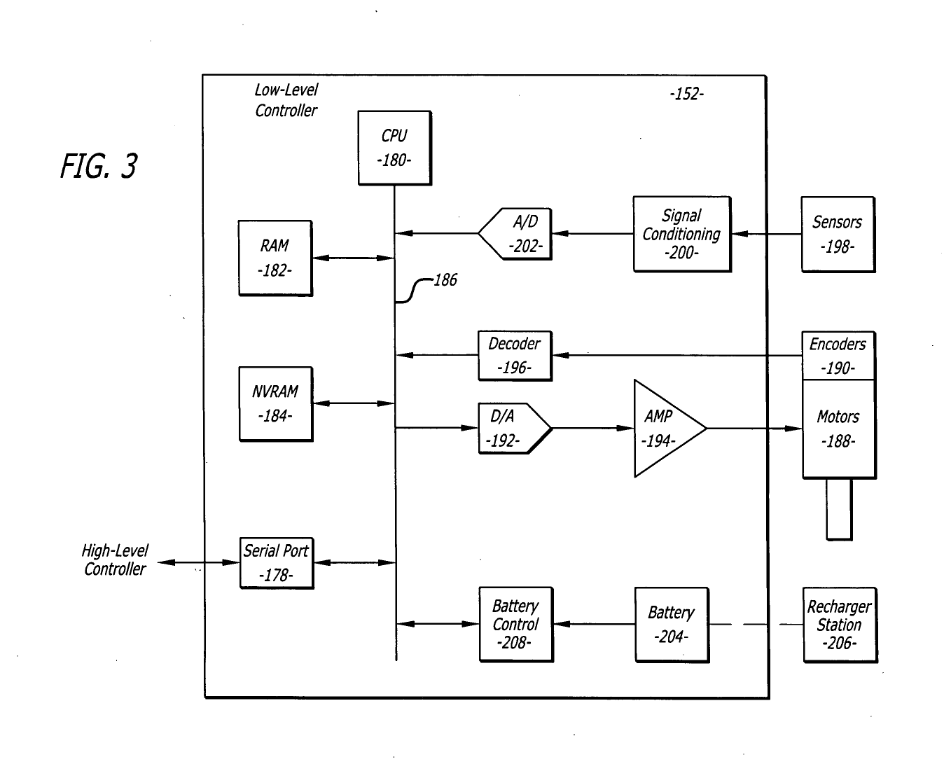

FIGS. 2 and 3 show an embodiment of a robot 12. Each robot 12 may include a high level control system 150 and a low level control system 152. The high level control system 150 may include a processor 154 that is connected to a bus 156. The auxiliary video port 70 is coupled to the robot cameras 40 and 42 and the external video devices 72. The port 70 may include a frame grabber that has multiple composite video inputs that allow the robot to capture video from the cameras 40 and 42 and the video devices 72. The port 70 provides video from one of the video devices, or cameras 40 or 42, based on input from the remote control station 16. For example, the port 70 may feed video from camera 40 and then switch the feed to one of the video devices 72.

The monitor 44 is coupled to the bus 156 by a serial output port 160 and a VGA driver 162. The monitor 44 may include a touchscreen function that allows the patient to enter input by touching the monitor screen.

The speaker 48 is coupled to the bus 156 by a digital to analog converter 164. The microphone 46 is coupled to the bus 156 by an analog to digital converter 166. The high level controller 150 may also contain random access memory (RAM) device 168, a non-volatile RAM device 170 and a mass storage device 172 that are all coupled to the bus 156. The mass storage device 172 may contain medical files of the patient that can be accessed by the user at the remote control station 16. For example, the mass storage device 172 may contain a picture of the patient. The user, particularly a health care provider, can recall the old picture and make a side by side comparison on the monitor 24 with a present video image of the patient provided by the camera 40. The robot antennae 50 may be coupled to a wireless transceiver 174. By way of example, the transceiver 174 may transmit and receive information in accordance with IEEE 802.11b.

The controller 154 may operate with a LINUX OS operating system. The controller 154 may also operate MS WINDOWS along with video, camera and audio drivers for communication with the remote control station 16. Video information may be transceived using MPEG CODEC compression techniques. The software may allow the user to send e-mail to the patient and vice versa, or allow the patient to access the Internet. In general the high level controller 150 operates to control communication between the robot 12 and the remote control station 16.

The remote control station 16 may include a computer that is similar to the high level controller 150. The computer would have a processor, memory, I/O, software, firmware, etc. for generating, transmitting, receiving and processing information.

The high level controller 150 may be linked to the low level controller 152 by serial ports 176 and 178. The low level controller 152 includes a processor 180 that is coupled to a RAM device 182 and non-volatile RAM device 184 by a bus 186. Each robot 12 contains a plurality of motors 188 and motor encoders 190. The motors 188 can actuate the movement platform and move other parts of the robot such as the monitor and camera. The encoders 190 provide feedback information regarding the output of the motors 188. The motors 188 can be coupled to the bus 186 by a digital to analog converter 192 and a driver amplifier 194. The encoders 190 can be coupled to the bus 186 by a decoder 196. Each robot 12 also has a number of proximity sensors 198 (see also FIG. 1). The position sensors 198 can be coupled to the bus 186 by a signal conditioning circuit 200 and an analog to digital converter 202.

The low level controller 152 runs software routines that mechanically actuate the robot 12. For example, the low level controller 152 provides instructions to actuate the movement platform to move the robot 12. The low level controller 152 may receive movement instructions from the high level controller 150. The movement instructions may be received as movement commands from the remote control station or another robot. Although two controllers are shown, it is to be understood that each robot 12 may have one controller, or more than two controllers, controlling the high and low level functions.

The various electrical devices of each robot 12 may be powered by a battery(ies) 204. The battery 204 may be recharged by a battery recharger station 206 (see also FIG. 1). The low level controller 152 may include a battery control circuit 208 that senses the power level of the battery 204. The low level controller 152 can sense when the power falls below a threshold and then send a message to the high level controller 150.

The system 10 may be the same or similar to a robotic system provided by the assignee InTouch-Health, Inc. of Santa Barbara, Calif. under the name RP-6 or RP-7. The system may also be the same or similar to the system disclosed in U.S. Pat. No. 6,925,357 issued to Wang et al. on Aug. 2, 2005, which is hereby incorporated by reference.

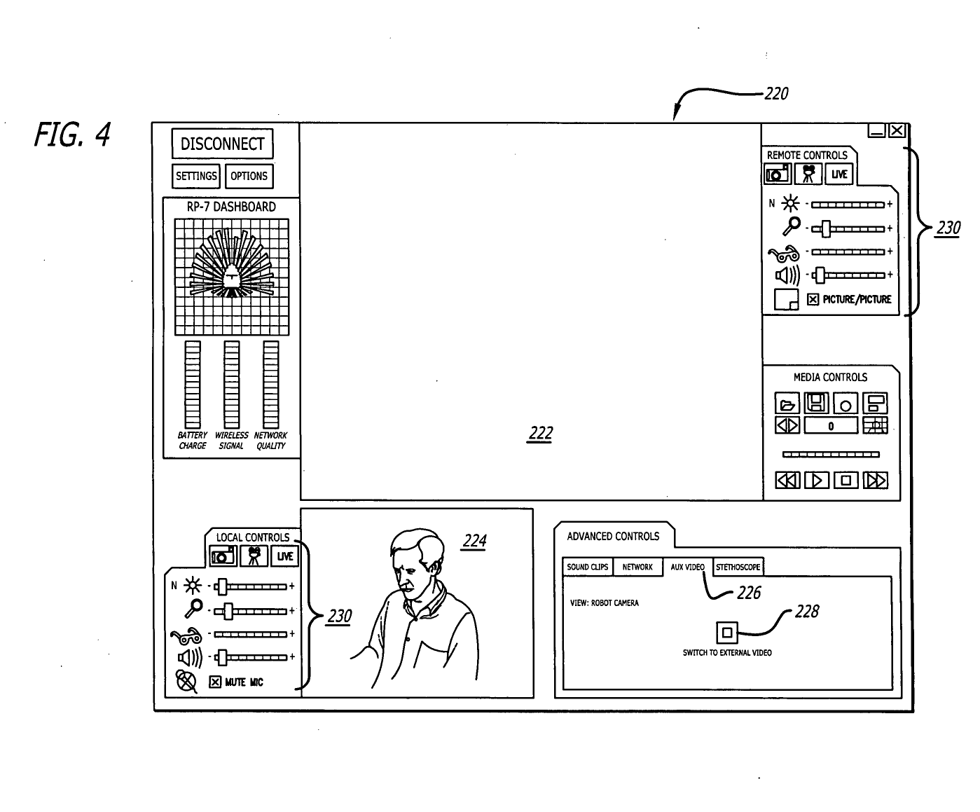

FIG. 4 shows a display user interface (“DUI”) 220 that can be displayed at the remote station 16. The DUI 220 may include a robot view field 222 that displays a video image provided by one of the cameras 40 or 42, or one of the video devices 72 at the robot location. The DUI 220 may include a station view field 224 that displays a video image provided by the camera of the remote station 16. The DUI 220 may be part of an application program stored and operated by the computer 22 of the remote station 16.

The display user interface 220 may include a Aux Video graphical tab 226 that display a button 228. The button 228 can be selected by a user to display video provided by one of the video devices 72 in the robot view field 222. The interface 220 may have additional graphical icons 230 that allow the user to adjust different parameters of the system such as camera brightness, audio volume, capturing a still picture, etc.

The user can highlight a portion of a non-zoom image to display a zoom image that corresponds to the highlighted area. Additionally, the user can circle, annotate, etc. portions of video with a telestrator function of the system 10.

In operation, the robot 12 may be placed in a home or a facility where one or more patients are to be monitored and/or assisted. The facility may be a hospital or a residential care facility. By way of example, the robot 12 may be placed in a home where a health care provider may monitor and/or assist the patient. Likewise, a friend or family member may communicate with the patient. The cameras and monitors at both the robot and remote control stations allow for teleconferencing between the patient and the person at the remote station(s).

The robot 12 can be maneuvered through the home or a facility by manipulating the input device 32 at a remote station 16. The robot 10 may be controlled by a number of different users. To accommodate for this the robot may have an arbitration system. The arbitration system may be integrated into the operating system of the robot 12. For example, the arbitration technique may be embedded into the operating system of the high-level controller 150.

By way of example, the users may be divided into classes that include the robot itself, a local user, a caregiver, a doctor, a family member, or a service provider. The robot 12 may override input commands that conflict with robot operation. For example, if the robot runs into a wall, the system may ignore all additional commands to continue in the direction of the wall. A local user is a person who is physically present with the robot. The robot could have an input device that allows local operation. For example, the robot may incorporate a voice recognition system that receives and interprets audible commands.

A caregiver is someone who remotely monitors the patient. A doctor is a medical professional who can remotely control the robot and also access medical files contained in the robot memory. The family and service users remotely access the robot. The service user may service the system such as by upgrading software, or setting operational parameters.

The robot 12 may operate in one of two different modes; an exclusive mode, or a sharing mode. In the exclusive mode only one user has access control of the robot. The exclusive mode may have a priority assigned to each type of user. By way of example, the priority may be in order of local, doctor, caregiver, family and then service user. In the sharing mode two or more users may share access with the robot. For example, a caregiver may have access to the robot, the caregiver may then enter the sharing mode to allow a doctor to also access the robot. Both the caregiver and the doctor can conduct a simultaneous teleconference with the patient.

The arbitration scheme may have one of four mechanisms; notification, timeouts, queue and call back. The notification mechanism may inform either a present user or a requesting user that another user has, or wants, access to the robot. The timeout mechanism gives certain types of users a prescribed amount of time to finish access to the robot. The queue mechanism is an orderly waiting list for access to the robot. The call back mechanism informs a user that the robot can be accessed. By way of example, a family user may receive an e-mail message that the robot is free for usage. Tables I and II, show how the mechanisms resolve access request from the various users.

TABLE I

| | Access | Medical | Command | Software/Debug | Set |
|---|---|---|---|---|---|
| User | Control | Record | Override | Access | Priority |
| Robot | No | No | Yes (1) | No | No |
| Local | No | No | Yes (2) | No | No |
| Caregiver | Yes | Yes | Yes (3) | No | No |
| Doctor | No | Yes | No | No | No |
| Family | No | No | No | No | No |
| Service | Yes | No | Yes | Yes | Yes |

TABLE II

| | Requesting User | | | | | |
|---|---|---|---|---|---|---|
| | Local | | Caregiver | Doctor | Family | Service |
| Current | Local | Not Allowed | Warn current user of | Warn current user of | Warn current user of | Warn current user of |
| User | | | pending user | pending user | pending user | pending user |
| | | | Notify requesting | Notify requesting user | Notify requesting user | Notify requesting |
| | | | user that system is in | that system is in use | that system is in use | user that system is in |
| | | | use | Set timeout = 5 m | Set timeout = 5 m | use |
| | | | Set timeout | | Call back | No timeout |
| | | | | | | Call back |
| | Caregiver | Warn current user | Not Allowed | Warn current user of | Warn current user of | Warn current user of |
| | | of pending user. | | pending user | pending user | pending user |
| | | Notify requesting | | Notify requesting user | Notify requesting user | Notify requesting |
| | | user that system is | | that system is in use | that system is in use | user that system is in |
| | | in use. | | Set timeout = 5 m | Set timeout = 5 m | use |
| | | Release control | | Queue or callback | | No timeout |
| | | | | | | Callback |
| | Doctor | Warn current user | Warn current user of | Warn current user of | Notify requesting user | Warn current user of |
| | | of pending user | pending user | pending user | that system is in use | pending user |
| | | Notify requesting | Notify requesting | Notify requesting user | No timeout | Notify requesting |
| | | user that system is | user that system is in | that system is in use | Queue or callback | user that system is in |
| | | in use | use | No timeout | | use |
| | | Release control | Set timeout = 5 m | Callback | | No timeout |
| | | | | | | Callback |
| | Family | Warn current user | Notify requesting | Warn current user of | Warn current user of | Warn current user of |
| | | of pending user | user that system is in | pending user | pending user | pending user |
| | | Notify requesting | use | Notify requesting user | Notify requesting user | Notify requesting |
| | | user that system is | No timeout | that system is in use | that system is in use | user that system is in |
| | | in use | Put in queue or | Set timeout = 1 m | Set timeout = 5 m | use |
| | | Release Control | callback | | Queue or callback | No timeout |
| | | | | | | Callback |
| | Service | Warn current user | Notify requesting | Warn current user of | Warn current user of | Not Allowed |
| | | of pending user | user that system is in | request | pending user | |
| | | Notify requesting | use | Notify requesting user | Notify requesting user | |
| | | user that system is | No timeout | that system is in use | that system is in use | |
| | | in use | Callback | No timeout | No timeout | |
| | | No timeout | | Callback | Queue or callback | |

The information transmitted between the station 16 and the robot 12 may be encrypted. Additionally, the user may have to enter a password to enter the system 10. A selected robot is then given an electronic key by the station 16. The robot 12 validates the key and returns another key to the station 16. The keys are used to encrypt information transmitted in the session.

The robot 12 and remote station 16 transmit commands through the broadband network 18. The commands can be generated by the user in a variety of ways. For example, commands to move the robot may be generated by moving the joystick 32 (see FIG. 1). The commands are preferably assembled into packets in accordance with TCP/IP protocol. Table III provides a list of control commands that are generated at the remote station and transmitted to the robot through the network.

TABLE III
Control Commands

| Command | Example | Description |
|---|---|---|
| drive | drive 10.0 0.0 5.0 | The drive command directs the robot to move |
| | | at the specified velocity (in cm/sec) in the |
| | | (x, y) plane, and turn its facing at the |
| | | specified rate (degrees/sec). |
| goodbye | goodbye | The goodbye command terminates a user |
| | | session and relinquishes control of the |
| | | robot |
| gotoHomePosition | gotoHomePosition 1 | The gotoHomePosition command moves the head |
| | | to a fixed “home” position (pan and tilt), |
| | | and restores zoom to default value. The |
| | | index value can be 0, 1, or 2. The exact |
| | | pan/tilt values for each index are specified |
| | | in robot configuration files. |
| head | head vel pan 5.0 tilt | The head command controls the head motion. |
| | 10.0 | It can send commands in two modes, |
| | | identified by keyword: either positional |
| | | (“pos”) or velocity (“vol”). In velocity |
| | | mode, the pan and tilt values are desired |
| | | velocities of the head on the pan and tilt |
| | | axes, in degree/sec. A single command can |
| | | include just the pan section, or just the |
| | | tilt section, or both. |
| keepalive | keepalive | The keepalive command causes no action, but |
| | | keeps the communication (socket) link open |
| | | so that a session can continue. In scripts, |
| | | it can be used to introduce delay time into |
| | | the action. |
| odometry | odometry 5 | The odometry command enables the flow of |
| | | odometry messages from the robot. The |
| | | argument is the number of times odometry is |
| | | to be reported each second. A value of 0 |
| | | turns odometry off. |
| reboot | reboot | The reboot command causes the robot computer |
| | | to reboot immediately. The ongoing session |
| | | is immediately broken off. |
| restoreHeadPosition | restoreHeadPosition | The restoreHeadPosition functions like the |
| | | gotoHomePosition command, but it homes the |
| | | head to a position previously saved with |
| | | gotoHomePosition. |
| saveHeadPosition | saveHeadPosition | The saveHeadPosition command causes the |
| | | robot to save the current head position (pan |
| | | and tilt) in a scratch location in temporary |
| | | storage so that this position can be |
| | | restored. Subsequent calls to |
| | | “restoreHeadPosition” will restore this |
| | | saved position. Each call to |
| | | saveHeadPosition overwrites any previously |
| | | saved position. |
| setCameraFocus | setCameraFocus 100.0 | The setCameraFocus command controls focus |
| | | for the camera on the robot side. The value |
| | | sent is passed “raw” to the video |
| | | application running on the robot, which |
| | | interprets it according to its own |
| | | specification. |
| setCameraZoom | setCameraZoom 100.0 | The setCameraZoom command controls zoom for |
| | | the camera on the robot side. The value |
| | | sent is passed “raw” to the video |
| | | application running on the robot, which |
| | | interprets it according to its own |
| | | specification. |
| shutdown | Shutdown | The shutdown command shuts down the robot |
| | | and powers down its computer. |
| stop | stop | The stop command directs the robot to stop |
| | | moving immediately. It is assumed this will |
| | | be as sudden a stop as the mechanism can |
| | | safely accommodate. |
| timing | Timing 3245629 500 | The timing message is used to estimate |
| | | message latency. It holds the UCT value |
| | | (seconds + milliseconds) of the time the |
| | | message was sent, as recorded on the sending |
| | | machine. To do a valid test, you must |
| | | compare results in each direction (i.e., |
| | | sending from machine A to machine B, then |
| | | from machine B to machine A) in order to |
| | | account for differences in the clocks |
| | | between the two machines. The robot records |
| | | data internally to estimate average and |
| | | maximum latency over the course of a |
| | | session, which it prints to log files. |
| userTask | userTask “Jane Doe” | The userTask command notifies the robot of |
| | “Remote Visit” | the current user and task. It typically is |
| | | sent once at the start of the session, |
| | | although it can be sent during a session if |
| | | the user and/or task change. The robot uses |
| | | this information for record-keeping. |

Table IV provides a list of reporting commands that are generated by the robot and transmitted to the remote station through the network.

TABLE IV
Reporting Commands

| Command | Example | Description |
|---|---|---|
| abnormalExit | abnormalExit | This message informs the user that the robot |
| | | software has crashed or otherwise exited |
| | | abnormally. Te robot software catches top- |
| | | level exceptions and generates this message |
| | | if any such exceptions occur. |
| bodyType | bodyType 3 | The bodyType message informs the station |
| | | which type body (using the numbering of the |
| | | mechanical team) the current robot has. |
| | | This allows the robot to be drawn correctly |
| | | in the station user interface, and allows |
| | | for any other necessary body-specific |
| | | adjustments. |
| driveEnabled | driveEnabled true | This message is sent at the start of a |
| | | session to indicate whether the drive system |
| | | is operational. |
| emergencyShutdown | emergencyShutdown | This message informs the station that the |
| | | robot software has detected a possible |
| | | “runaway” condition (an failure causing the |
| | | robot to move out of control) and is |
| | | shutting the entire system down to prevent |
| | | hazardous motion. |
| odometry | odometry 10 20 340 | The odometry command reports the current |
| | | (x, y) position (cm) and body orientation |
| | | (degrees) of the robot, in the original |
| | | coordinate space of the robot at the start |
| | | of the session. |
| sensorGroup | group_data | Sensors on the robot are arranged into |
| | | groups, each group of a single type (bumps, |
| | | range sensors, charge meter, etc.) The |
| | | sensorGroup message is sent once per group |
| | | at the start of each session. It contains |
| | | the number, type, locations, and any other |
| | | relevant data for the sensors in that group. |
| | | The station assumes nothing about the |
| | | equipment carried on the robot; everything |
| | | it knows about the sensors comes from the |
| | | sensorGroup messages. |
| sensorState | groupName state data | The sensorState command reports the current |
| | | state values for a specified group of |
| | | sensor. The syntax and interpretation for |
| | | the state data is specific to each group. |
| | | This message is sent once for each group at |
| | | each sensor evaluation (normally several |
| | | times per second). |
| systemError | systemError | This message informs the station user of a |
| | driveController | failure in one of the robot's subsystems. |
| | | The error_type argument indicates which |
| | | subsystem failed, including driveController, |
| | | sensorController, headHome. |
| systemInfo | systemInfo wireless 45 | This message allows regular reporting of |
| | | information that falls outside the sensor |
| | | system such as wireless signal strength. |
| text | text “This is some | The text string sends a text string from the |
| | text” | robot to the station, where the string is |
| | | displayed to the user. This message is used |
| | | mainly for debugging. |
| version | version 1.6 | This message identifies the software version |
| | | currently running on the robot. It is sent |
| | | once at the start of the session to allow |
| | | the station to do any necessary backward |
| | | compatibility adjustments. |

The processor 154 of the robot high level controller 150 may operate a program that determines whether the robot 12 has received a robot control command within a time interval. For example, if the robot 12 does not receive a control command within 2 seconds then the processor 154 provides instructions to the low level controller 150 to stop the robot 12. Although a software embodiment is described, it is to be understood that the control command monitoring feature could be implemented with hardware, or a combination of hardware and software. The hardware may include a timer that is reset each time a control command is received and generates, or terminates, a command or signal, to stop the robot.

The remote station computer 22 may monitor the receipt of video images provided by the robot camera. The computer 22 may generate and transmit a STOP command to the robot if the remote station does not receive or transmit an updated video image within a time interval. The STOP command causes the robot to stop. By way of example, the computer 22 may generate a STOP command if the remote control station does not receive a new video image within 2 seconds. Although a software embodiment is described, it is to be understood that the video image monitoring feature could be implemented with hardware, or a combination of hardware and software. The hardware may include a timer that is reset each time a new video image is received and generates, or terminates, a command or signal, to generate the robot STOP command.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A remote controlled robot system, comprising:
a mobile robot with a robot monitor, and a robot camera that captures a robot image, said mobile robot having an auxiliary video port;
a video device that is coupled to said auxiliary video port and can provide video; and,
a remote control station that transmits commands to control said mobile robot, said remote control station includes a monitor that displays the robot image captured by said robot camera and the video provided by said video device, said remote control station including a camera that can capture a station image that is displayed by said robot monitor.

2. The system of claim 1, wherein said video device is an otoscope.

3. The system of claim 1, wherein said auxiliary video port can receive video from a plurality of video devices.

4. The system of claim 1, wherein said video device is an external camera.

5. The system of claim 1, wherein said remote control station displays a graphical user interface with an auxiliary video graphical input that can be selected by a user to display video from said video device.

6. The system of claim 1, further comprising a broadband network coupled to said mobile robot and said remote control station.

7. The system of claim 1, wherein said robot camera and said robot monitor move together.

8. A remote controlled robot system, comprising:
a video device;
a mobile robot with a robot monitor, and a robot camera that captures a robot image, said mobile robot having auxiliary video means for transmitting video from said video device;
a remote control station that transmits commands to control said mobile robot, said remote control station includes a monitor that displays the robot image captured by said robot camera and the video from said video device, said remote control station including a camera that can capture a station image that is displayed by said robot monitor.

9. The system of claim 8, wherein said video device is an otoscope.

10. The system of claim 8, wherein said auxiliary video can receive video from a plurality of video devices.

11. The system of claim 8, wherein said video device is an external camera.

12. The system of claim 8, wherein said remote control station displays a graphical user interface with an auxiliary video graphical input that can be selected by a user to display video from said video device.

13. The system of claim 8, further comprising a broadband network coupled to said mobile robot and said remote control station.

14. The system of claim 8, wherein said robot camera and said robot monitor move together.

15. A method for transferring images, comprising:
capturing a robot image with a robot camera of a mobile robot;
transmitting the robot image captured by the robot camera to a remote control station used to control movement of the mobile robot;
displaying the image captured by the robot camera on a monitor of the remote control station;
capturing a station image with a camera of the remote control station;
transmitting the station image to the mobile robot;
displaying the station image on a monitor of the mobile robot;
coupling a video device to an auxiliary video port of the mobile robot;
capturing video with the video device;
transmitting the video to the remote control station; and,
displaying the video on the remote control station monitor.

16. The method of claim 15, further comprising coupling a plurality of video devices to the auxiliary video port.

17. The method of claim 15, further comprising selecting a graphical input of a graphical user interface displayed by the remote control station monitor to display the video from the video device.

18. The method of claim 15, wherein the video is transmitted through a broadband network.

19. The method of claim 15, further comprising moving the robot camera and the robot monitor together.
